(19) United States
(12) Patent Application Publication
(10) Pub. No.: US 2010/0047394 A1
(43) Pub. Date: Feb. 25, 2010

(54) PRODUCT CONTAINING LIVING PROBIOTIC MICROORGANISMS

(75) Inventor: Maximilian Emanuel May, Freiburg (DE)

Correspondence Address: SCULLY SCOTT MURPHY & PRESSER, PC, 400 GARDEN CITY PLAZA, SUITE 300, GARDEN CITY, NY, 11530, US

(73) Assignee: AMADEUS ALEXANDER MAY, Appenzell (CH)

(21) Appl. No.: 12/525,659

(22) PCT Filed: Jan. 16, 2008
(86) PCT No.: PCT/EP2008/000298

§ 371 Date: Oct. 9, 2009

(30) Foreign Application Priority Data
Feb. 2, 2007 (EP) 07002352.8

(51) Int. Cl. A23L 1/28; B65D 25/08

(52) U.S. Cl. 426/62; 426/61; 206/219

(57) ABSTRACT

The present invention relates to a liquid fermented natural product which contains live probiotic microorganisms in an amount of 10⁵ to 10¹⁵ cells/ml, wherein the fraction of dead microorganisms is present in excess, and also to a process for producing this natural product, and to a vessel for storage thereof.

The present invention relates to a liquid fermented natural product that contains living probiotic microorganisms, to a process for producing this natural product, and to a container for storage thereof.

Designated as natural products are products that represent products of nature, such as, for example, the milk of animals. Natural products are also those products which are produced from naturally occurring raw materials, such as, for example, from fruits and vegetables.

For some years there has been an increasing trend towards a healthy, balanced diet. In this connection the consumption of natural products is playing an ever greater role.

The enrichment of natural products with, in particular, probiotic bacteria is also constantly gaining in importance in this context. In the case of probiotic bacteria, it is a question, by definition, of viable microorganisms that are capable of positively influencing the health of human beings.

For instance, the equilibrium of the intestinal flora of human beings may have been disturbed by various loads such as stress, antibiotics, alcohol and food that is low in ballast material, or in the case of diseases of the digestive organs, as a result of which the natural intestinal flora are no longer capable of defending themselves against foreign, harmful germs. Medicaments can also bring about a change in the composition of the intestinal environment, in particular antibiotics and antimycotics, which partly destroy the intestinal flora.

Probiotic bacteria help to re-establish the equilibrium of the intestinal flora and to keep it stable by changing the composition of the intestinal flora of human beings and positively influencing the part of the immune system that is associated with the intestinal wall. As a result of the production of metabolites—for example, lactic acid and hydrogen peroxide—probiotic bacteria worsen, for example, the habitat conditions of undesirable microorganisms in the intestine. Their presence in the intestine improves the digestive function. In addition, probiotic bacteria in the intestine produce substances that are important for human beings, such as niacin, folic acid and pyridoxine.

The most well-known probiotic bacteria include the lactobacilli and bifidobacteria, which belong to the order of the lactic-acid bacteria. In order that probiotic bacteria achieve the desired effects, their consumption has to be completely safe. In addition, they have to arrive in the intestine in relatively large numbers in a living condition, in order to colonize there, and must not be destroyed by the gastric acid when passing through the stomach.

Liquid natural products that contain probiotic bacteria are known from the state of the art.

For instance, WO 01/58465 A2 describes the addition of living lactobacillus bacteria or bifidobacteria to a pharmaceutically acceptable carrier, milk for example, in order to treat and prevent intestinal infections in infants.

U.S. Pat. No. 5,531,988 discloses a dry composition that includes an effective quantity of beneficial microorganisms of the human intestine, for example lactobacillus bacteria or bifidobacteria, and an effective quantity of an active immunoglobulin composition which contributes to promoting the health of the gastro-intestinal tract of human beings. This dry composition can be consumed by being suspended in a liquid, for example in water or in fruit juice, prior to consumption.

WO 99/17788 A1 relates to a composition for treating fungal diseases that includes both living and dead lactic-acid bacteria. The composition may be present in liquid form and may additionally contain proteins, carbohydrates, fats and vitamins.

As mentioned in the introduction, natural products are also products that are produced from naturally occurring raw materials. It is known that such natural products can serve particularly well for enhancing the physical well-being and the personal fitness of human beings if they are broken down with the aid of microorganisms. The process in which naturally occurring raw materials—for example, fruit, vegetables and/or pulses—are decomposed by microorganisms, for example lactic-acid bacteria, is designated as fermentation. As a result of the fermentation, the bioavailability of the raw materials that are used increases. By virtue of the fact that the raw materials are converted into their individual constituents by the fermenting, they can be better taken up and utilised by the body, which has a positive effect on the metabolism of human beings.

Natural fermented beverages that are produced from tea, bread, milk, vegetables or fruits and that contain lactic-acid bacteria are likewise known. JP 63-251070 A discloses, for example, a fruit-juice beverage fermented by lactic-acid bacteria, for example Lactobacillus bulgaricus, Streptococcus thermophilus or Lactobacillus casei.

Moreover, EP 1 153 549 B1 describes a liquid natural product fermented by microorganisms, for example Lactobacillus rhamnosus, that no longer contains living bacteria. It is produced by a multi-stage fermentation process and consists of a plurality of decomposition products that can be utilised by human beings.

EP 1 289 380 B1 relates to a process for producing a food product, a beverage for example, that contains non-viable lactobacillus bacteria, the process comprising the addition of a mixture of viable and non-viable lactobacillus bacteria, followed by the inactivation of the viable bacteria.

However, it has turned out that the previously known liquid natural products fermented by microorganisms have the disadvantage that, despite a relatively large range of effectiveness, they are not effective enough, precisely with regard to immunity-stimulating mechanisms in the body.

It can therefore be regarded as an object of the present invention to make available a liquid fermented natural product that is distinguished by a particularly broad range of effectiveness with special activation of the immune system.

It can, moreover, be regarded as an object to make available a process with which a liquid fermented natural product can be produced with particular care.

Finally, it can be regarded as an object to make available a container for storing a liquid fermented natural product, in which the natural product does not lose its particularly high effectiveness.

These objects are achieved with the features of Claims 1, 15 and 28.

The present invention relates to a liquid fermented natural product that contains living probiotic microorganisms in a quantity from 10⁵ to 10¹⁵ cells/ml, the proportion of dead microorganisms being present in excess.

The dependent claims relate to preferred embodiments of the natural product according to the invention.

The invention relates, moreover, to a process for producing a liquid fermented natural product that contains living probiotic microorganisms, the proportion of dead microorganisms being present in excess, with the following stages: (i) providing a liquid fermented natural product, (ii) adding probiotic microorganisms in a quantity from 10⁵ to 10¹⁵ cells/ml to the liquid fermented natural product and (iii) mixing the probiotic microorganisms with the liquid fermented natural product immediately prior to consumption.

The dependent claims relate to preferred embodiments of the process according to the invention.

In addition, the invention relates to a container for holding a liquid fermented natural product that contains living probiotic microorganisms, the proportion of dead microorganisms being present in excess, the container exhibiting at least two chambers, with the liquid fermented natural product being contained in the first chamber, and at least the probiotic microorganisms being contained in the second chamber.

The dependent claims relate to preferred embodiments of the container according to the invention.

It has surprisingly turned out that with the liquid fermented natural product according to the invention the positive effects of living probiotic microorganisms and of dead microorganisms on the human organism can be combined with one another and can consequently be potentiated by a unique synergism.

The positive effects of the natural product according to the invention may be described in detail as follows:

The diverse decomposition products in a fermented natural product can be utilised by the human body much more easily, which has positive effects on the metabolism of human beings. In addition, the improved bioavailability of a fermented natural product heightens the general well-being and the physical fitness of human beings.

The administration of living probiotic microorganisms promotes the health of the gastro-intestinal tract. For example, probiotic bacteria are able to colonize in the intestine and in this way strengthen the part of the immune system that is associated with the intestinal wall. As a result of the formation of metabolites—such as, for example, lactic acid and hydrogen peroxide—probiotic bacteria are able to aggravate the habitat conditions of undesirable microorganisms that are detrimental to health, and consequently are able to shift the microbiological equilibrium in the intestine towards health-promoting microorganisms. Probiotic bacteria shorten or lessen diarrhoeal illnesses and promote the digestion of lactose. Furthermore, they are helpful in the case of chronic inflammatory intestinal diseases. Studies have shown that probiotic bacteria are also effective against allergies. In addition, they are able to lower the cholesterol level, reduce the risk of diseases of the coronary vessels, and lessen the number of fungal infections (mycoses).

Dead microorganisms also result in an intensification of the immune strength of the human organism. Accordingly, in particular the cell-wall parts and cell constituents of dead bacteria—such as, for example, peptides, glucanes, phospholipids, polysaccharides and the substance murein—are able to stimulate the immune system of human beings. This immunity-stimulating effect is explained by the fact that the bacteria that have been killed activate the innate part of the body's own defence, which is available at any time. They act in the body as a kind of alarm signal in respect of intruders, whereupon the immune system is mobilised. In the course of this mobilisation the activity of macrophages, for example, is increased. In addition, the leucocytes are brought to attention. An excessive reaction of the immune system, however, is prevented by the occurrence of an anti-inflammatory effect, like a metabolic pendulum. In addition, it is assumed that a prebiotic role is played by the constituents of the dead bacteria. Prebiotic substances are able to promote the growth of quite particular bacteria of the human intestine. In simplified terms, it is assumed that the constituents of the dead bacteria serve as nutriment for the probiotic bacteria in the intestine.

The natural product according to the invention, which synergistically combines the effect of a fermented product and the effect of dead and living probiotic microorganisms, is consequently particularly beneficial and effective for the human organism. It is distinguished by a particularly broad range of effectiveness.

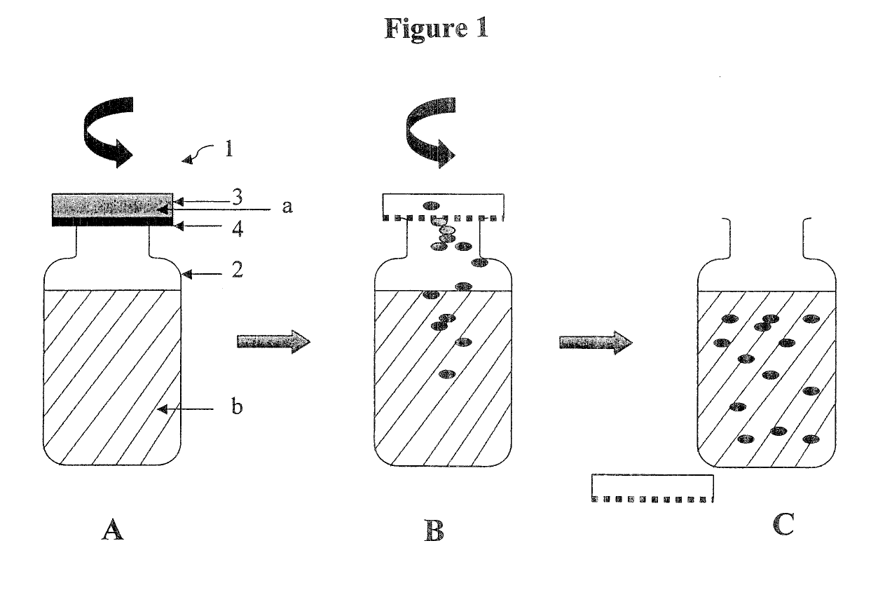

FIG. 1 shows an example of a container for storing the natural product according to the invention.

It has proved particularly advantageous for the effect on the human organism if the natural product according to the invention contains living probiotic microorganisms in a quantity from 10⁵ to 10¹⁵ cells/ml and the proportion of dead microorganisms (in relation to the living bacteria) is present in excess.

The natural product according to the invention preferably contains the probiotic microorganisms in a quantity from 10⁶ to 10¹² cells/ml. A quantity from 10⁸ to 10¹⁰ cells/ml is particularly preferred.

The natural product according to the invention is preferably pasteurised. Such a product can be produced, for example, by the process described in EP 1 153 549 B1.

The natural product according to the invention preferably consists of a ferment or of a ferment extract of raw materials. In this connection the expression ‘ferment of raw materials’ is to be understood to mean a mixture of substances that contains both soluble and insoluble constituents. It has the advantage that it is rich in water-insoluble ballast substances. The unpurified ferment constitutes a concentrate that is particularly substantial for the consumer and suitable as a healthy source of energy. A ferment extract of raw materials once again constitutes a filtrate that has been purified by, for example, centrifugation and/or filtration. From such a filtrate the insoluble constituents are removed. It constitutes a naturally cloudy liquid.

The liquid fermented natural product is preferably based on fruits, vegetables, pulses, herbs and/or nuts of any kind. The mixture as such is regarded as not critical. Practically any variation consisting of fruits, vegetables and pulses is possible. Use is preferably made of raw materials derived from ecologically controlled cultivation.

The probiotic microorganisms are preferably contained in the natural product according to the invention in, for example, lyophilised form.

In a preferred embodiment, the natural product according to the invention includes probiotic microorganisms that are selected from bacteria, fungi, yeasts and/or mixtures thereof. In particularly preferred manner, bacteria are included.

The natural product according to the invention preferably includes, by way of probiotic bacteria, at least one bacterium of the order Lactobacillales (lactic-acid bacteria). In an alternative embodiment of the invention, the microorganisms are present in the natural product in the form of a mixture of Lactobacillales with other probiotic microorganisms.

Lactobacillales are Gram-positive, always anaerobic but mostly aerotolerant bacteria which are distinguished by the fact that they decompose sugars to lactic acid. They are among the most important representatives of the human intestinal flora. In particular the administration of Lactobacillales is therefore able to re-establish the equilibrium of the intestinal flora and keep it stable. The natural product according to the invention, which includes Lactobacillales, can consequently serve for heightening the physical well-being of human beings.

The families Lactobacillaceae, Aerococcaceae, Carnobacteriaceae, Enterococcaceae, Leuconostocaceae and Streptococcaceae belong to the order Lactobacillales.

The natural product according to the invention preferably contains bacteria of the family Lactobacillaceae.

Particularly preferably, the natural product according to the invention includes bacteria of the genus Lactobacillus. Still more preferably, bacteria of the species Lactobacillus rhamnosus are contained in the natural product according to the invention. The administration of bacteria of the species Lactobacillus rhamnosus has surprisingly proved to be particularly immunity-intensifying in a whole-blood study. The natural product according to the invention, which contains this species of bacteria, is accordingly highly effective.

Most preferably, the natural product according to the invention includes bacteria of the species Lactobacillus rhamnosus and at least one other probiotic microorganism, depending on the particular range of effectiveness.

The natural product according to the invention preferably further contains additives, such as, for example, secondary plant substances, for example lutein, vitamins, minerals, fatty acids, polysaccharides, polyglucanes and/or extracts from fungi.

In accordance with the invention, the process for producing a liquid fermented natural product that contains living probiotic microorganisms, the proportion of dead microorganisms being present in excess, in particular for producing a natural product according to the invention, exhibits the following stages: (i) making available a liquid fermented natural product, (ii) adding probiotic microorganisms in a quantity from 10⁵ to 10¹⁵ cells/ml to the liquid fermented natural product and (iii) mixing probiotic microorganisms with the liquid fermented natural product immediately prior to consumption.

The process according to the invention is preferably carried out with probiotic microorganisms in a quantity from 10⁶ to 10¹² cells/ml, because this quantity has turned out to be particularly effective for the human organism. In particularly preferred manner, the process according to the invention is carried out with probiotic microorganisms in a quantity from 10⁸ to 10¹⁰ cells/ml, because this quantity has turned out to be highly effective for the human organism.

The expression ‘immediately prior to consumption’ is to be understood to mean a period from a few seconds up to 16 hours which may elapse between the production of the natural product and the consumption thereof. Ordinarily, the natural product is consumed within one minute to a maximum of 10 minutes, for example in the form of a daily dose. But the natural product may also be ingested in a manner distributed over the day, for example in the form of a part-dose in the morning and in the evening, at an interval of up to 16 hours. Since the probiotic microorganisms are transferred to the liquid fermented natural product only shortly prior to consumption, high effectiveness is guaranteed.

With the aid of the process according to the invention, a liquid fermented natural product that contains probiotic microorganisms can be produced with particular care.

By virtue of the process according to the invention, a liquid fermented natural product is produced that contains both living and dead microorganisms. The proportion of dead microorganisms is present in excess. Such a natural product is particularly effective. As already described, precisely the combination of living and dead bacteria has a particularly stimulating effect on the immune system of human beings. Whereas living bacteria act on the human organism probiotically, it is assumed that a prebiotic action can be ascribed to the constituents of the dead bacteria. Furthermore, the diverse constituents of a fermented natural product can contribute to increasing the metabolic activity of human beings.

In the process according to the invention, use is preferably made of a liquid fermented natural product that is pasteurised in advance.

The term ‘pasteurisation’ is generally understood to mean the brief heating of substances to 60° C. to 90° C. for the purpose of killing microorganisms. Such a product can be produced, for example, by the process described in EP 1 153 549 B1. In EP 1 153 549 B1 the pasteurising may be carried out at the end of the fermentation process, in order to kill all the living microorganisms in the fermented product.

It is advantageous that, as a result of the pasteurising, the shelf life of the natural product is increased. The natural product does not change its characteristics upon being pasteurised; consistency and taste are preserved.

In the process according to the invention, microorganisms are preferably added in lyophilised form, because lyophilised microorganisms display a good survival-rate during storage. In order to keep the vitality of the microorganisms high for as long as possible, the microorganisms are therefore added to a liquid fermented natural product only immediately prior to consumption.

In a preferred embodiment of the process according to the invention, the microorganisms are chosen from bacteria, fungi, yeasts and/or mixtures thereof. In particularly preferred manner, use is made of bacteria.

In the process according to the invention, at least one bacterium of the order Lactobacillales (lactic-acid bacteria) are preferably added to a liquid fermented natural product by way of probiotic bacteria. Lactic-acid bacteria are among the most important representatives of the human intestinal flora. It has become evident that the substitution of at least one bacterium of the order of bacteria Lactobacillales is able to re-establish the equilibrium of a disturbed intestinal flora and keep it stable. It is particularly health-promoting to ingest at least one bacterium of the order Lactobacillales for the purpose of preventing gastro-intestinal diseases and for the purpose of stimulating the immune system.

Bacteria of the family Lactobacillacea are preferably added. In particularly preferred manner in the process according to the invention, use is made of bacteria of the genus Lactobacillus. Most preferably, bacteria of the species Lactobacillus rhamnosus are employed in the process according to the invention, because they have turned out to be particularly immunity-promoting.

In a special embodiment of the process according to the invention, at least one probiotic microorganism of the order Lactobacillales is employed in a mixture with at least one other probiotic microorganism. The combination of bacteria of the species Lactobacillus rhamnosus with at least one other probiotic microorganism, depending on the respective range of effectiveness, has turned out to be highly effective.

The invention further relates to a container for holding a liquid fermented natural product that contains living probiotic microorganisms, the dead microorganisms being present in excess, the container exhibiting at least two chambers, with the liquid fermented natural product being contained in the first chamber, and at least the probiotic microorganisms being contained in the second chamber.

The second chamber preferably further contains additives, such as, for example, secondary plant substances, for example lutein, vitamins, minerals, fatty acids, polysaccharides, polyglucanes and/or extracts from fungi. These constituents are preferably present in lyophilised form. It has become evident that the addition of secondary plant substances, for example lutein, vitamins, minerals, fatty acids, polysaccharides, polyglucanes and/or extracts from fungi, further increases the effectiveness of the natural product according to the invention. The picking of these constituents is undertaken individually and depends on the desired range of effectiveness. For example, the circle of consumers plays a role in the selection of the individual constituents. Whereas women have an increased need for folic acid, iron, magnesium, zinc and biotin, the substitution of vitamins K, B5, B9, B2 presents itself in men. Athletes have an increased need for sodium, calcium, magnesium, zinc, vitamins E and C.

One of the two chambers is preferably pot-shaped, and the other of the two chambers is formed by a closure with which the first chamber is capable of being locked. For example, on the inside the closure may exhibit a screw thread for screw coupling.

The chamber that is formed by the closure is preferably sealed with an interlayer. The interlayer may be formed from a vegetable fibrous material or from plastic. The interlayer preferably consists of paper or of a film of plastic, since these materials exhibit a low tear resistance.

The container may consist of glass or plastic. Glass is particularly preferred, because the liquid fermented natural product may leave coloured residues on plastic. Furthermore, the container may be formed from any other material, provided that it is suitable for storing the natural product according to the invention.

The container may be present in any desired form. Use is preferably made of bottles in order to store the natural product according to the invention, since they can be handled particularly well.

The container according to the invention has the advantage that probiotic bacteria and a liquid fermented natural product can be stored separately from one another. Only shortly prior to consumption, when the container is opened, are probiotic bacteria added to a liquid fermented natural product, as a result of which the natural product according to the invention is produced. Consequently, the individual constituents of the natural product in the container according to the invention can be kept for a particularly long time without their effectiveness diminishing.

As already described, a fermented, liquid natural product, which is located in the first chamber of the container according to the invention, enhances, by virtue of its high bioavailability, the general well-being and the physical fitness of human beings. In addition, the dead microorganisms contained in it heighten the immune strength of human beings. Besides, it is assumed that a prebiotic action is to be ascribed to the constituents of dead bacteria. The probiotic microorganisms, which the second chamber of the container according to the invention holds, are both immunity-enhancing and favourable for the health of the gastro-intestinal tract. As a result of the opening of the container, the probiotic microorganisms from the second chamber are combined with the liquid fermented natural product in the first chamber, and hence the positive effects thereof are also combined. The natural product according to the invention that is produced by this process is therefore distinguished by its particularly high effectiveness.

An exemplary embodiment for storing the natural product according to the invention is represented In FIG. 1. FIG. 1A shows, by way of container 1 according to the invention, a sealable bottle with a closure. The bottle exhibits two chambers 2, 3. The first chamber 2 is pot-shaped. In the exemplary embodiment, it is formed by the bottle. The bottle has a screw thread. It contains the liquid fermented natural product b. The second chamber 3 is formed by a closure. In the exemplary embodiment, the closure is a closure for screw coupling. The second chamber 3 is sealed by an interlayer 4. In the exemplary embodiment, the interlayer consists of paper. The probiotic bacteria a are contained in the cavity of the closure.

The container 1 is configured in such a way that, by virtue of a relative movement between the two chambers 2 and 3, here accordingly between the bottle and the closure, for example by rotation, the second chamber 3 can be opened, for example by the interlayer being destroyed (see FIG. 1B). In this way, the probiotic bacteria which are contained in the closure can be passed into the liquid fermented natural product. The container 1 is further configured in such a way that, as a result of continuing the relative movement, for example by further rotation, the second chamber 3—in the exemplary embodiment, the closure—can be completely separated from the first chamber 2—in the exemplary embodiment, the bottle (see FIG. 1C). From the container 1 which has been opened in such a way, the liquid fermented natural product, which contains probiotic bacteria, can be consumed. The container can be sealed again in appropriate manner.

The container 1 may have a capacity from 10 ml to 350 ml. Preferably the container 1 may have a capacity from 10 ml to 30 ml. Particularly preferred is a container 1 with a capacity of 20 ml, because this quantity corresponds to the recommended daily dose of the natural product according to the invention. Such a container 1 has the advantage that, after opening, the entire contents are used up. The natural product according to the invention consequently cannot lose effectiveness as a result of further storage.

The natural product according to the invention is a biological product. It may be administered both internally and externally. For internal administration, as a rule it is given orally by way of foodstuff, food, food supplement, dietetic foodstuff, or in the form of a balanced diet. As a rule, 20 ml per day (daily dose) of the natural product according to the invention are ingested. This dose may also be divided and, for example, consumed in the form of a part-dose in the morning and in the evening.

It has turned out that the natural product according to the invention can also be applied externally on the skin. In this case it has proved particularly favourable if the liquid fermented natural product is fed into packs, compresses, and is then placed onto the areas of skin concerned. It may also be applied directly in the form of spray solution.

The invention will be illustrated on the basis of the following example, though without restriction thereto.

### EXAMPLE

The liquid fermented natural product is produced by the process described in EP 1 153 549 B1. To this liquid fermented natural product there are added, immediately prior to consumption, living bacteria of the species Lactobacillus rhamnosus or a bacterial mixture including Lactobacillus rhamnosus in a quantity of 10⁹ cells/ml. The probiotic bacteria or the bacterial mixture are subsequently carefully mixed with the liquid fermented natural product. The product is consequently available for immediate consumption.

1. Liquid fermented natural product based on fruits, vegetables, pulses, herbs and/or nuts that contains added living probiotic microorganisms in a quantity from 10⁵ to 10¹⁵ cells/ml, the proportion of dead microorganisms being present in excess.

2. Natural product according to claim 1, characterised in that it contains the probiotic microorganisms in a quantity from 10⁶ to 10¹² cells/ml.

3. Natural product according to claim 2, characterised in that it contains the probiotic microorganisms in a quantity from 10⁸ to 10¹⁰ cells/ml.

4. Natural product according to claim 1, characterised in that the natural product has been pasteurised prior to the addition of the living probiotic microorganisms.

5. Natural product according to claim 1, characterised in that it consists of a ferment or of a ferment extract of raw materials.

6. Natural product according to claim 1, characterised in that the probiotic microorganisms are selected from bacteria, fungi, yeasts and/or mixtures thereof.

7. Natural product according to claim 6, characterised in that the probiotic microorganisms are bacteria.

8. Natural product according to claim 1, characterised in that it contains probiotic microorganisms in lyophilised form.

9. Natural product according to claim 6, characterised in that the probiotic bacteria include at least one bacterium of the order Lactobacillales.

10. Natural product according to claim 9, characterised in that the named bacteria are bacteria of the family Lactobacillacea.

11. Natural product according to claim 10, characterised in that the named bacteria are bacteria of the genus Lactobacillus.

12. Natural product according to claim 11, characterised in that the named bacteria are bacteria of the species Lactobacillus rhamnosus.

13. Natural product according to claim 1, characterised in that the microorganisms are present in the form of a mixture of Lactobacillales with other probiotic microorganisms.

14. Natural product according to claim 1, characterised in that it further contains secondary plant substances, vitamins, minerals, fatty acids, polysaccharides, polyglucanes and/or extracts from fungi.

15. Process for producing a liquid fermented natural product based on fruits, vegetables, pulses, herbs and/or nuts that contains added living probiotic microorganisms in a quantity from 10⁵ to 10¹⁵ cells/ml, the proportion of dead microorganisms being present in excess, with the following stages:
(i) making available a liquid fermented natural product based on fruits, vegetables, pulses, herbs and/or nuts,
(ii) adding probiotic microorganisms in a quantity from 10⁵ to 10¹⁵ cells/ml to the liquid fermented natural product and
(iii) mixing the probiotic microorganisms with the liquid fermented natural product immediately prior to consumption.

16. Process according to claim 15, characterised in that the probiotic microorganisms are added in a quantity from 10⁶ to 10¹² cells/ml to the liquid fermented natural product.

17. Process according to claim 15, characterised in that the probiotic microorganisms are added in a quantity from 10⁸ to 10¹⁰ cells/ml to the liquid fermented natural product.

18. Process according to claim 15, characterised in that the natural product of (i) is pasteurised in advance.

19. Process according to claim 15, characterised in that bacteria, fungi, yeasts and/or mixtures thereof are added by way of probiotic microorganisms.

20. Process according to claim 19, characterised in that bacteria are added by way of probiotic microorganisms.

21. Process according to claim 15, characterised in that the probiotic microorganisms are added in lyophilised form.

22. Process according to claim 15, characterised in that the added probiotic bacteria include at least one bacterium of the order Lactobacillales.

23. Process according to claim 22, characterised in that the added bacteria are bacteria of the family Lactobacillacea.

24. Process according to claim 23, characterised in that the added bacteria are bacteria of the genus Lactobacillus.

25. Process according to claim 24, characterised in that the added bacteria are bacteria of the species Lactobacillus rhamnosus.

26. Process according to claim 15, characterised in that at least one microorganism of the order Lactobacillales is employed in a mixture with at least one other probiotic microorganism.

27. A container for holding a liquid fermented natural product based on fruits, vegetables, pulses, herbs and/or nuts that contains added living probiotic microorganisms in a quantity from 10⁵ to 10¹⁵ cells/ml, the proportion of dead microorganisms being present in excess, the container exhibiting at least two chambers, with the liquid fermented natural product being contained in the first chamber, and at least the probiotic microorganisms being contained in the second chamber, and wherein the second chamber can be opened by a relative movement between the chambers.

28. Container according to claim 27, characterised in that one of the two chambers is pot-shaped and the other of the two chambers is formed by a closure with which the first chamber is capable of being locked.

29. Container according to claim 27, characterised in that the second chamber exhibits an interlayer.

30. Container according to claim 27, characterised in that the first chamber and the second chamber exhibit a screw thread.

31. Container according to claim 27, characterised in that secondary plant substances, vitamins, minerals, fatty acids, polysaccharides, polyglucanes and/or extracts from fungi are further contained in the second chamber.

32.-34. (canceled)
